(19) United States
(12) Patent Application Publication
(10) Pub. No.: US 2011/0083137 A1
(43) Pub. Date: Apr. 7, 2011

(54) APPLICATION COOPERATION METHOD, SYSTEM, COMPUTER-READABLE MEDIUM, AND INFORMATION PROCESSING APPARATUS

(75) Inventor: Atsushi Kashioka, Yokohama-shi (JP)

(73) Assignee: CANON KABUSHIKI KAISHA, Tokyo (JP)

(21) Appl. No.: 12/872,324

(22) Filed: Aug. 31, 2010

(30) Foreign Application Priority Data
Oct. 1, 2009 (JP) 2009-229996

(51) Int. Cl. G06F 9/46

(52) U.S. Cl. 719/315

(57) ABSTRACT

An application cooperation method comprises: a holding step of holding correspondence between functions provided by applications and operation categories which categorize operation contents for the object by the functions provided by the applications; an acquisition step of acquiring an object managed by a first application, and acquiring an operation authority of a user for the object managed by the first application; an object information management step of storing and managing, as object information, the object and the operation authority for the object acquired in the acquisition step in the storage unit; and a determination step of determining whether or not operation categories held in the holding step in correspondence with functions of a second application which processes the object managed as the object information in the object information management step are permitted for the operation authority for the object managed as the object information.

### BACKGROUND OF THE INVENTION

1. Field of the Invention

The present invention relates to an application cooperation method, system, computer-readable medium, and information processing apparatus for cooperating a plurality of applications. More particularly, the present invention relates to a technique required to exchange objects without posing any security problem between a plurality of applications in an environment in which respective applications have different authentication methods, and are managed by individual access authorities.

2. Description of the Related Art

Nowadays, with the aim of improving operational efficiency within companies, applications, systems, and services (to be collectively referred to as applications hereinafter) have been individually introduced in respective departments or throughout entire companies. More specifically, ERP (Enterprise Resource Planning), SCM (Supply Chain Management), and the like are known.

In recent years, as an architecture or concept required to pursue agility that aims at providing competitive superiority, SOA (Service-Oriented Architecture) has received a lot of attention. SOA proposes an architecture that divides functions of existing applications in a company, which run individually, into respective service units, and configures a total system by combining them. Furthermore, in an environment in which respective applications have different authentication methods, and are managed by individual access authorities, as a mechanism for solving a problem that a user is required to execute authentication every time he or she uses these applications, a method called SSO (Single Sign-On) or Federation has been proposed.

In this case, a measure against any security problem when a plurality of applications exchange objects is required. For example, when a document management application which can manage user's access authorities for respective documents and another application cooperate regardless of any security, a problem of information leakage may occur. For example, when a given user has a read privilege but does not have any print privileges for a certain document, he or she may extract the document from the document management application, and can then print using a print management application, which is managed by an access authority different from that of the document management application.

As related work for solving the aforementioned problem, a method using a policy server that sets and manages security control functions in a plurality of applications in an integrated fashion is available. More specifically, a user's access authority to each document is set in advance as a policy. When the user attempts to access that document, each application accesses the policy server to acquire a policy of that user for that document, thus controlling operations to the document.

A document security maintenance system which allows consistent maintenance of securities associated with generation or copying of documents in respective domains even when documents (paper documents) are exchanged between different domains has been proposed (see Japanese Patent Laid-Open No. 2005-196338). Japanese Patent Laid-Open No. 2005-196338 realizes integrated security management in an environment across security domains by specifying a document by embedding an identifier in each paper document.

Furthermore, a document management system which allows an application to be accessible in the same manner as other documents in a format common to a document management system, so as to allow easy and effective cooperations with various applications by a simple configuration has been proposed (see Japanese Patent Laid-Open No. 2006-048426). Japanese Patent Laid-Open No. 2006-048426 realizes security management using an authority of an execution user by creating data required for an application based on an application information file, and launching an application in response to the transferred data.

However, in the related art using the policy server, respective applications access the policy server to determine whether or not to permit operations based on the access authority of a user. Furthermore, at a timing when the user performs an operation for a document, a given application requests the policy server for a policy for the given user. Hence, should a fault occur in the policy server or the network, the user must repeat the same set of operations despite being in an environment in which he or she is permitted to operate the document.

In Japanese Patent Laid-Open No. 2005-196338, digital data is not a target, but a processing logic which directly inquires a security server, and acquires and determines an operation permission across domains is required to be individually installed in respective information devices. In Japanese Patent Laid-Open No. 2006-048426, the launched application determines the authority of the execution user using parameter values passed from the document management server, and a determination logic has to be installed in all applications to be launched.

### SUMMARY OF THE INVENTION

The present invention provides a method which can obviate the need for individual installation of processing logic required to determine whether or not to permit an operation for an object received from another application in respective applications, even when a plurality of applications process objects in cooperation with each other.

According to one aspect of the present invention, there is provided an application cooperation method in a system which comprises storage unit, and cooperation unit for cooperating a plurality of applications, managed by different access authorities, by exchanging an object between the plurality of applications, the method comprising: a holding step of holding correspondence between functions provided by applications and operation categories which categorize operation contents for the object by the functions provided by the applications; an acquisition step of acquiring an object managed by a first application, and acquiring an operation authority of a user for the object managed by the first application; an object information management step of storing and managing, as object information, the object and the operation authority for the object acquired in the acquisition step in the storage unit; and a determination step of determining whether or not operation categories held in the holding step in correspondence with functions of a second application which processes the object managed as the object information in the object information management step are permitted for the operation authority for the object managed as the object information, wherein the operation categories are defined to be commonly used between the plurality of applications, the cooperation unit does not pass the object managed as the object information in the object information management step to the second application at the time of execution of the function provided by the second application corresponding to the operation category which is not permitted according to a result in the determination step, and the cooperation unit passes the object managed as the object information in the object information management step to the second application at the time of execution of the function provided by the second application corresponding to the operation category which is permitted according to the result in the determination step.

According to another aspect of the present invention, there is provided a system which comprises cooperation unit for cooperating a plurality of applications, managed by different access authorities, by exchanging an object between the plurality of applications, the system comprising: holding unit for holding correspondence between functions provided by applications and operation categories which categorize operation contents for the object by the functions provided by the applications; acquisition unit for acquiring an object managed by a first application, and acquiring an operation authority of a user for the object managed by the first application; object information management unit for managing, as object information, the object and the operation authority for the object acquired by the acquisition unit; and determination unit for determining whether or not operation categories held by the holding unit in correspondence with functions of a second application which processes the object managed as the object information by the object information management unit are permitted for the operation authority for the object managed as the object information, wherein the cooperation unit processes not to pass the object managed as the object information by the object information management unit to the second application at the time of execution of the function provided by the second application corresponding to the operation category which is not permitted according to a result of the determination unit, the cooperation unit processes to pass the object managed as the object information by the object information management unit to the second application at the time of execution of the function provided by the second application corresponding to the operation category which is permitted according to the result of the determination unit, and the operation categories are defined to be commonly used between the plurality of applications.

According to another aspect of the present invention, there is provided an information processing apparatus which comprises cooperation unit for cooperating a plurality of applications, managed by different access authorities, by exchanging an object between the plurality of applications, the apparatus comprising: holding unit for holding correspondence between functions provided by applications and operation categories which categorize operation contents for the object by the functions provided by the applications; acquisition unit for acquiring an object managed by a first application, and acquiring an operation authority of a user for the object managed by the first application; object information management unit for managing the object and the operation authority for the object acquired by the acquisition unit as object information; and determination unit for determining whether or not operation categories held by the holding unit in correspondence with functions of a second application which processes the object managed as the object information by the object information management unit are permitted for the operation authority for the object managed as the object information, wherein the cooperation unit does not pass the object managed as the object information by the object information management unit to the second application at the time of execution of the function provided by the second application corresponding to the operation category which is not permitted according to a result of the determination unit, the cooperation unit passes the object managed as the object information by the object information management unit to the second application at the time of execution of the function provided by the second application corresponding to the operation category which is permitted according to the result of the determination unit, and the operation categories are defined to be commonly used between the plurality of applications.

According to the present invention, a method is provided that can obviate the need for individually installation of processing logic required to determine whether or not to permit an operation for an object received from another application in respective applications even when a plurality of applications process objects in cooperation with each other. In particular, according to the present invention, interdependency between a plurality of applications can be excluded while flexibly considering operation authorities of respective applications.

Since whether or not to permit execution of processing for an object is determined before an interface (function) provided by an application is called, unnecessary network communications and the like in a distributed environment can be avoided. Furthermore, since no external system such as a policy server, which provides integrated access authority management for all applications, is used, troublesome operations for a user who has to repeat the same operations repeatedly when the policy server and network suffer troubles are never required.

Further features of the present invention will become apparent from the following description of exemplary embodiments (with reference to the attached drawings).

### BRIEF DESCRIPTION OF THE DRAWINGS

FIGS. 1A and 1B are system diagrams of application cooperation systems according to the first embodiment;

FIG. 2 is a block diagram showing the hardware arrangement of an information processing apparatus according to the first embodiment;

FIG. 3 is a block diagram showing the software configuration of the application cooperation system according to the first embodiment;

FIGS. 4A and 4B are views showing an example of a user interface of the application cooperation system according to the present invention;

FIG. 5 is a flowchart of UI display processing according to the first embodiment;

FIG. 6 is a flowchart of login processing according to the first embodiment;

FIG. 7 is a flowchart of document search processing according to the first embodiment;

FIG. 8 is a flowchart of document acquisition processing according to the first embodiment;

FIG. 9 is a flowchart of user operation authority acquisition processing according to the first embodiment;

FIGS. 10A and 10B are views showing examples of definition files according to the first embodiment;

FIG. 11 is a flowchart of UI display processing according to the first embodiment;

FIG. 12 is a flowchart of comparison processing according to the first embodiment;

FIG. 13 is a flowchart of print processing according to the second embodiment;

FIG. 14 is a flowchart of document submission processing according to the second embodiment; and

FIG. 15 is a flowchart of print management application document submission processing according to the second embodiment.

### DESCRIPTION OF THE EMBODIMENTS

Embodiments for carrying out the present invention will be described hereinafter with reference to the drawings.

### First Embodiment

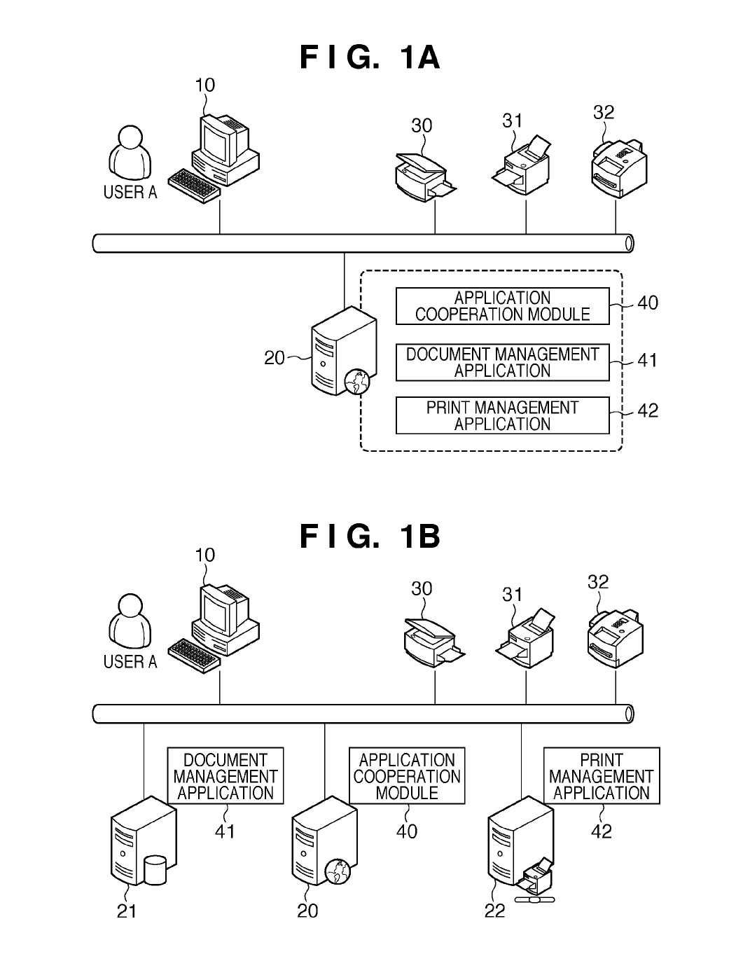

The first embodiment of the present invention will be described below with reference to FIGS. 1 to 12.

[System Arrangement]

FIG. 1A is a system diagram of an application cooperation system according to an embodiment of the present invention. To an application cooperation module 40 according to this embodiment, a Client PC 10 which allows user A to access via a browser, peripheral devices 30, 31, and 32 which have, for example, copy, print, scanner, and FAX functions, and an application server PC 20 which includes the application cooperation module 40 are connected via a network. The application server PC 20 includes a document management application 41 having a document management function, and a print management application 42 required to control print operations to the peripheral devices 30, 31, and 32 in addition to the application cooperation module 40. Note that the application cooperation module 40, document management application 41, and print management application 42 may be included in different application server PCs 20, 21, and 22, as shown in FIG. 1B. Also, the application server PCs 20, 21, and 22 need not always be connected to an intranet, but they may be connected to the Internet.

The application cooperation system adopts a configuration in which user A accesses via a browser, but a dedicated client application (not shown) may be included in the Client PC 10, and the user may operate it. This embodiment will explain a case in which the application cooperation module 40 controls to cooperate the document management application 41 and print management application 42. However, applications to be cooperated are not particularly limited. More specifically, an application (not shown) having a document edit function, format conversion function, and the like may be cooperated with the document management application 41. Note that the document management application 41 may be generally considered as a first application, and the print management application 42 may be generally considered as a second application.

[Hardware Arrangement]

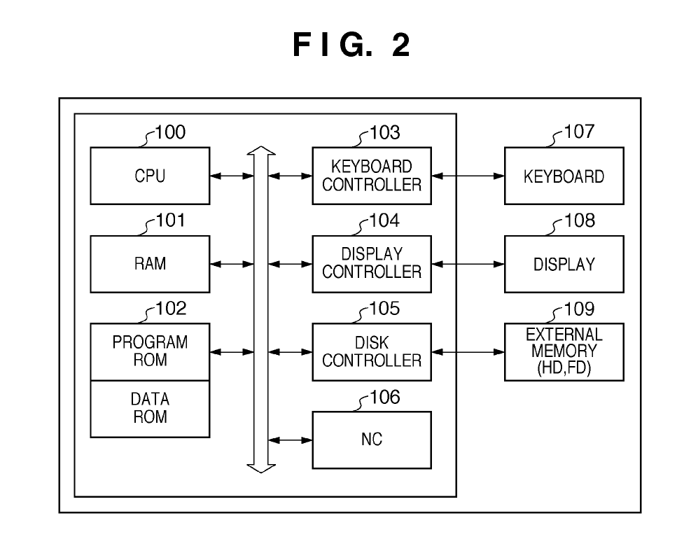

FIG. 2 is a block diagram showing the hardware arrangement of a PC that forms the application cooperation system according to the embodiment of the present invention. The hardware arrangement shown in FIG. 2 corresponds to that of a general information processing apparatus, and the hardware arrangement of the general information processing apparatus can be applied to the PC of this embodiment. Referring to FIG. 2, a CPU 100 executes programs such as an OS and applications, which are stored in a program ROM of a ROM 102 or which are loaded from an external memory 109 onto a RAM 101. Note that the OS is a short for an operating system which runs on a computer, and the operating system will be referred to as an OS hereinafter. Processes of respective flowcharts to be described later can be implemented by executing the programs. The RAM 101 serves as a main memory and work area of the CPU 100. A keyboard controller 103 controls key inputs from a keyboard 107 and a pointing device (not shown). A display controller 104 controls display of a display 108. A disk controller 105 controls data accesses to, for example, a hard disk (HD) 109 and Floppy® disk (FD), which store various data. An NC (Network Card) 106 is connected to a network, and executes communication control processing with other devices connected to the network.

[Software Configuration]

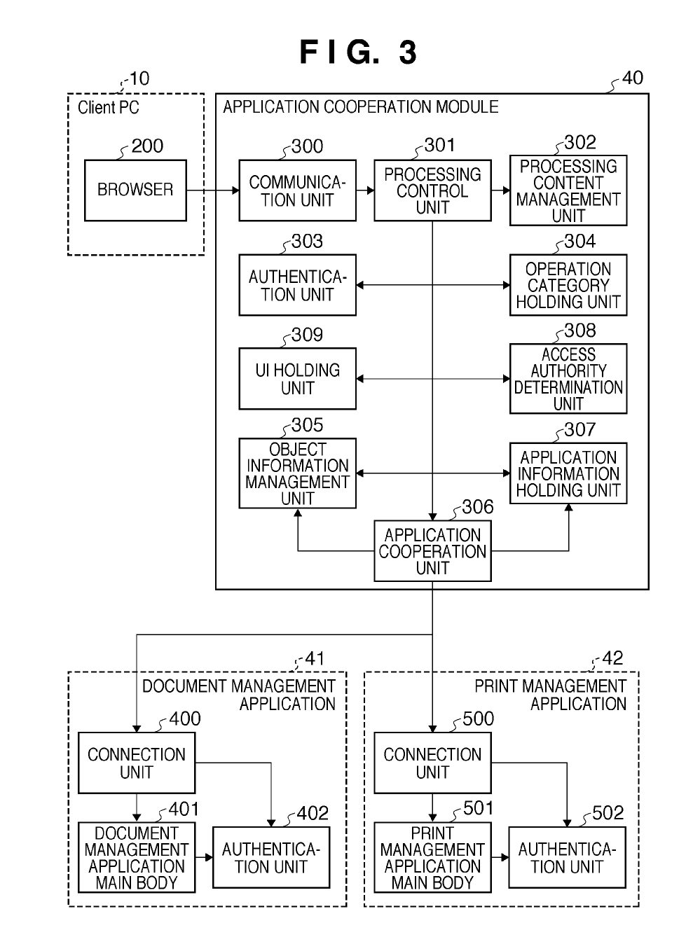

FIG. 3 is a block diagram showing an example of the software configuration of the application cooperation system according to the embodiment of the present invention. FIG. 3 shows the software configurations in the Client PC 10 and application server PC 20. The software configuration in the Client PC 10 will be described first.

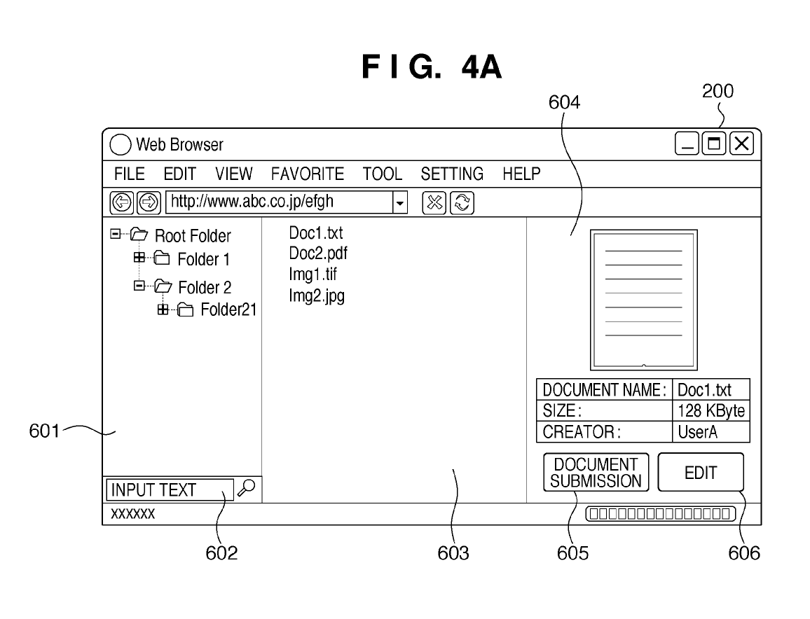

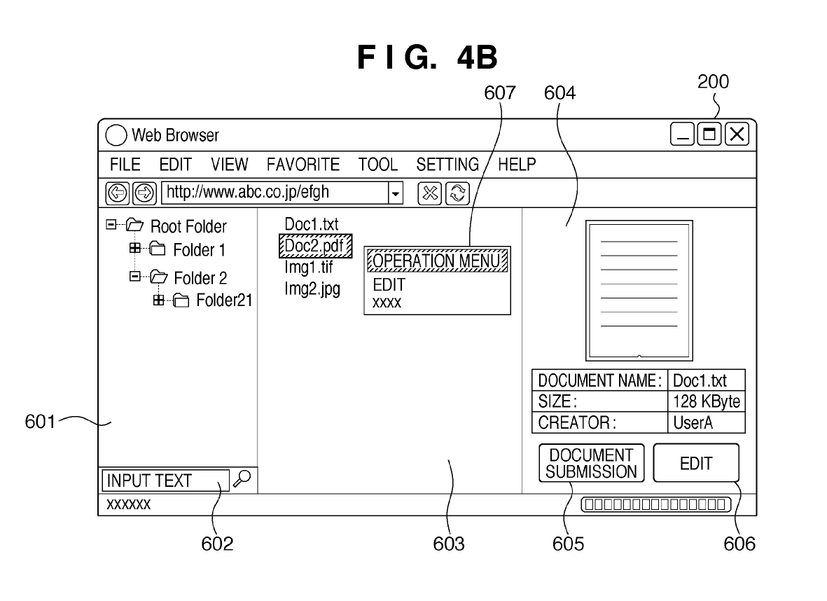

A browser 200 accesses the application cooperation module 40 of the embodiment of the present invention according to an operation by user A, and displays a user interface as a response. In this case, the browser 200 is a program file stored in the external memory 109 of the Client PC 10. The browser 200 is loaded onto the RAM 101 when it is executed, and is executed by the CPU 100. The executed browser 200 is displayed on the display 108, and user A operates the browser 200 using the keyboard 107 and pointing device (not shown). Note that the browser 200 can be a general Web browser such as Internet Explorer® or Firefox®. FIG. 4A shows an example of a user interface of the application cooperation module 40 displayed on the browser 200 of the Client PC 10.

The software configurations of the application cooperation module 40, document management application 41, and print management application 42 included in the application server PC 20 will be described below. Note that these pieces of software are stored as program files in the external memory 109 in the application server PC 20. These program files are loaded onto the RAM 101 in response to a request from the Client PC 10 and in accordance with an instruction from the OS, and are executed by the CPU 100.

A communication unit 300 receives a request from the browser 200 in the Client PC 10 via the NC 106, and transmits, as a response, a processing result in the application cooperation module 40 to the browser 200 via the NC 106. A processing control unit 301 controls the application cooperation module 40 according to this embodiment. The processing control unit 301 receives a request from the browser 200 via the communication unit 300, and instructs and manages respective units to be described below. A processing content management unit 302 manages a plurality of processes executed in the application cooperation module 40. The processing content management unit 302 receives an instruction from the processing control unit 301, and executes processes according to requests from the browser 200. In this case, the processes define calling of interfaces provided by respective applications, conditional branches, and the like as sequences, and are described using source codes or, for example, XML schemata.

An authentication unit 303 executes authentication judgment processing as to whether or not to permit an access with respect to a login operation of user A to the application cooperation module 40. Furthermore, once user A has logged in to the document management application 41 and print management application 42 via the application cooperation module 40, the authentication unit 303 temporarily holds login information to these applications. An operation category holding unit 304 holds operation categories for objects to be exchanged between the document management application 41 and print management application 42, which categories are defined by the application cooperation module 40. More specifically, operation categories called in the present invention are those which are defined by categorizing types of operation contents for objects such as CREATE (creation), READ (reading), UPDATE (updating), DELETE (deletion), PRINT (printing), COPY (copying), MOVE (movement), and ALL (all processes). Note that the operation categories are held in a database (not shown) or as a setting file in a format such as XML. Furthermore, the operation categories may be added, edited, and deleted via a user interface (not shown), or the database or setting file may be directly edited. Assume that as the number of operation categories, two or more operation categories are defined. Objects simply called in the present invention indicate document information and various application data managed by the document management application.

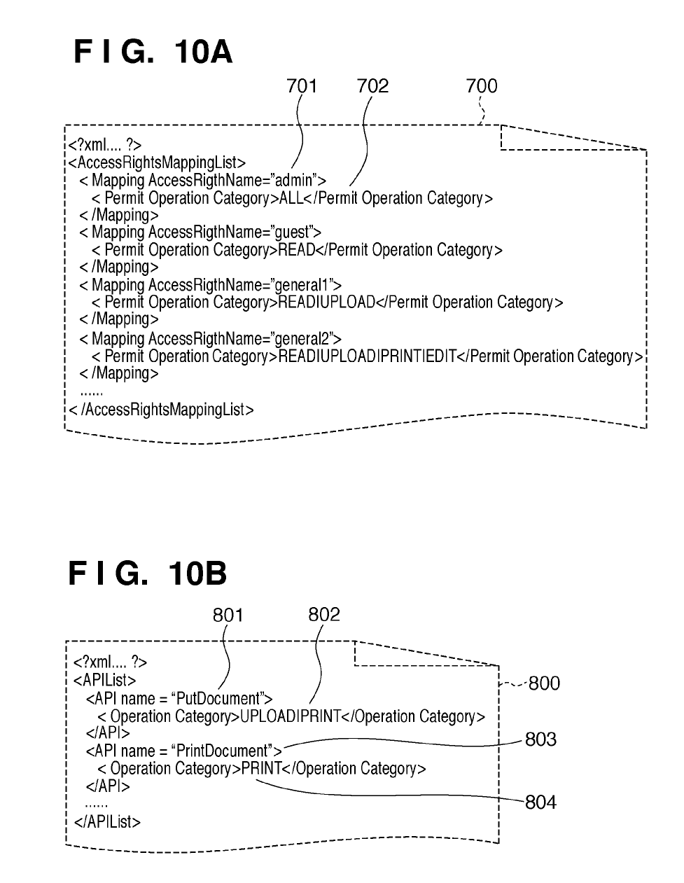

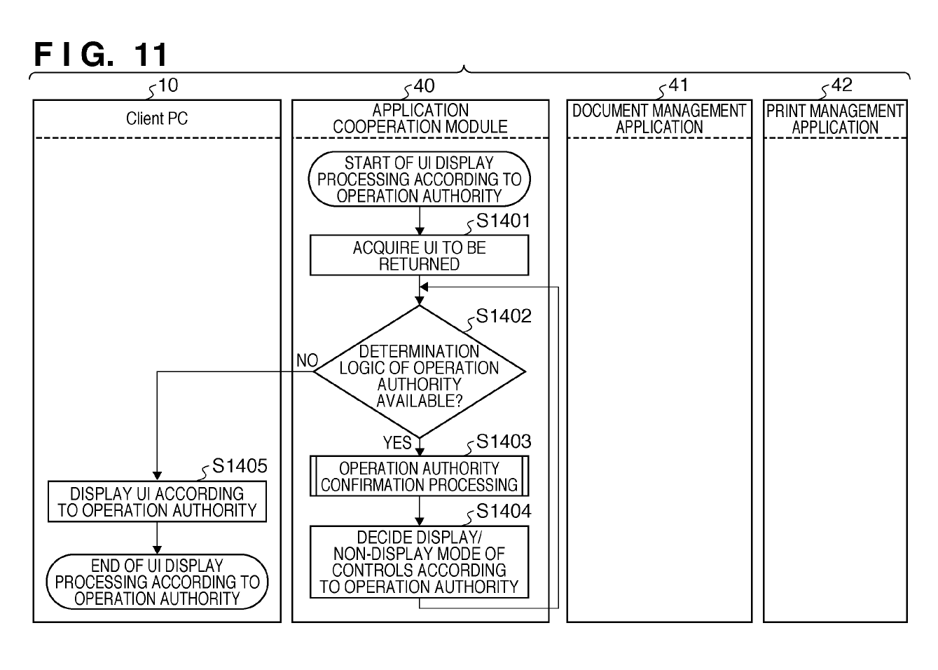

An object information management unit 305 stores and manages objects acquired from the document management application 41. Furthermore, the object information management unit 305 acquires, for example, an operation authority of user A for an object acquired from the document management application 41, and stores and manages it as an object attribute. Note that object information including an object and its attribute may hold information such as a size and date of creation, which depend on the object, in addition to the operation authority of user A. An application cooperation unit 306 calls interfaces provided by the document management application 41 and print management application 42 in accordance with the processes stored in the processing content management unit 302, and cooperates with the respective applications. An application information holding unit 307 holds information of interfaces provided by the document management application 41 and print management application 42. In this case, the interface information defines processing contents in an interface provided by each application. FIG. 10B shows an example of such interface information, that is, a definition file which indicates operation categories of an interface of the print management application 42.

An access authority determination unit 308 compares an operation authority of user A for an object, which is stored in the object information management unit 305, and operation categories of the interface of the print management application, which are stored in the application information holding unit 307. As a result of comparison, the access authority determination unit 308 determines whether or not to permit to call the interface of the print management application. A UI holding unit 309 stores a user interface which returns, as a response, the processing result of the application cooperation module 40 in response to a request from the browser 200. In this case, the user interface is not limited to HTML or Java Script® data, and may have any formats as long as it can be displayed by the browser 200.

A connection unit 400 of the document management application 41 accepts a call request from the application cooperation unit 306 of the application cooperation module 40. A document management application main body 401 executes processing in response to an instruction from the connection unit 400, and returns a processing result to the application cooperation unit 306. The connection unit 400 may be allowed to make communications via the network like REST or Web Service, or may be directly called from a source code like an interface class. An authentication unit 402 executes user management and access authority management in the document management application main body 401.

The software configuration in the print management application 42 is the same as that in the document management application 41, and includes a connection unit 500, print management application main body 501, and authentication unit 502.

Note that the present invention may be applied to an environment in which some of a plurality of applications have an identical authentication method, and are managed by an identical access authority. In this case, the present invention is applied to an environment in which respective applications have different authentication methods, and are managed by independent access authorities in correspondence with the system configurations, as shown in FIGS. 1A and 1B.

Processes in respective steps of the application cooperation system according to the first embodiment of the present invention will be described in detail below.

[UI Display According to Operation Authority]

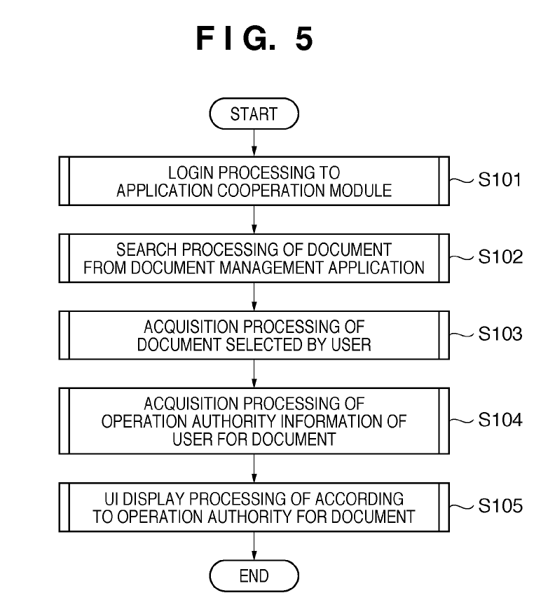

User A operates a UI according to an operation authority of the application cooperation system of the embodiment of the present invention via the browser 200 of the Client PC 10. FIG. 5 is a flowchart showing an overview of the sequence of UI display processing according to the operation authority. The UI display processing will be described below using FIGS. 3 and 5.

In step S101, when the communication unit 300 of the application cooperation module 40 according to this embodiment receives a login instruction from user A via the browser 200, the processing control unit 301 controls the authentication unit 303 to confirm whether or not to permit a login operation. In step S102, when the communication unit 300 receives a document search instruction from user A via the browser 200, the processing control unit 301 acquires a document search result from the document management application 41 via the application cooperation unit 306. In step S103, when the communication unit 300 receives a document selection instruction from user A via the browser 200, the processing control unit 301 acquires document information from the document management application 41 via the application cooperation unit 306. The processing control unit 301 stores object information based on the acquired document information in the object information management unit 305.

In step S104, the processing control unit 301 acquires the operation authority of user A for the document information acquired in step S103 from the document management application 41 via the application cooperation unit 306. The processing control unit 301 updates an object attribute of the object information by the acquired operation authority of user A, and stores the updated object information in the object information management unit 305. In step S105, the processing control unit 301 acquires a user interface to be returned to the browser 200 from the UI holding unit 309. Then, the processing control unit 301 acquires a definition file of an interface of the print management application 42 stored in the application information holding unit 307. The access authority determination unit 308 compares the operation authority of user A for the document information acquired in step S104 with operation categories described in the definition file of the interface of the print management application 42. The processing control unit 301 returns the user interface including invalidated (non-displayed or grayed-out) controls of the document for which user A does not have any operation authority so as to limit instructions for processes, to the browser 200 via the communication unit 300, and displays that user interface on the browser 200.

[Login]

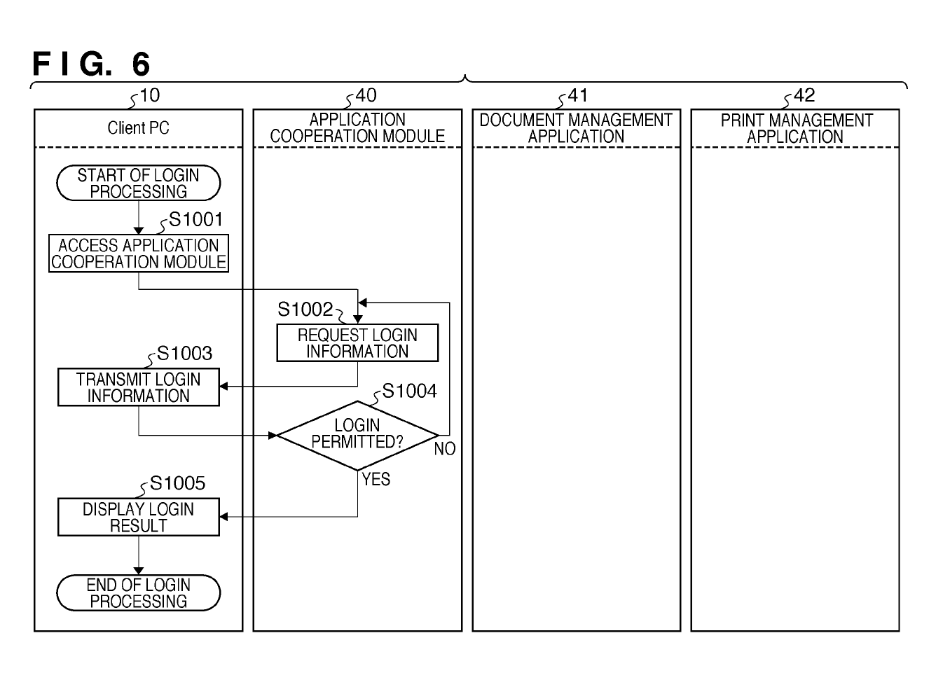

In step S101, user A logs in to a system environment provided by the application cooperation module 40 according to this embodiment by operating the browser 200 of the Client PC 10. FIG. 6 is a flowchart showing the sequence of login processing. The login processing will be described in detail below using FIGS. 3 and 6.

In step S1001, user A accesses the application cooperation module 40 by operating the browser 200 of the Client PC 10. In step S1002, when user A accesses the application cooperation module 40 via the browser 200 in step S1001, the communication unit 300 in the application cooperation module 40 receives an HTTP request. The processing control unit 301 receives a notification from the communication unit 300, and acquires a process corresponding to the request from user A from the processing content management unit 302. The processing control unit 301 acquires a user interface which requests the user to log in from the UI holding unit 309 according to the process acquired from the processing content management unit 302, and returns the acquired user interface to the browser 200 as a response via the communication unit 300. This embodiment will explain a case in which the application cooperation module 40 returns the login request user interface, but another method may request user A to log in. More specifically, when an HTTP request header from the browser 200 does not include any authentication information, a Web server function (not shown) of the application server PC 20 may return an HTTP 401 response code to the browser 200, and the browser 200 may display a login screen.

In step S1003, user A who received the login request in step S1002 inputs login information via the user interface displayed on the browser 200, and transmits that information to the application cooperation module 40. In step S1004, when user A transmits the login information to the application cooperation module 40 via the browser 200 in step S1003, the communication unit 300 receives a login request. The processing control unit 301 receives a notification from the communication unit 300, acquires a process corresponding to the request from user A from the processing content management unit 302, and controls, according to the acquired process, the authentication unit 303 in the application cooperation module 40 to determine whether or not to permit a login operation. More specifically, the authentication unit 303 manages a user information list, which is registered in advance, and determines whether or not a user name and password included in the login information transmitted by user A are included in the registered user information list. In this case, the login information is not limited to the user name and password. If the login operation has failed based on the login information input by the user, login information is requested again. If it is determined in step S1004 that the login operation has succeeded, the processing control unit 301 acquires a user interface from the UI holding unit 309 and returns it to the browser 200 as a response via the communication unit 300 in step S1005.

FIG. 4A shows an example of a user interface which is displayed on the browser 200 of the Client PC 10 after the user logs into the application cooperation module 40. The user interface includes a repository area 601, search window 602, document list area 603, preview area 604, document submission button 605, and edit button 606. The repository area 601 displays the internal structure of the document management application 41 using a tree view. The search window 602 is used to search for documents in the document management application 41. The document list area 603 displays documents in the form of thumbnails or icons. The preview area 604 displays a preview and property information of a document selected on the document list area 603. The document submission button 605 is used to instruct to submit the selected document to the print management application 42. The edit button 606 is used to instruct to edit the selected document. The user inputs an instruction to the application cooperation module 40 via the user interface displayed on the browser 200. Note that the format, area configurations, and controls associated with the user interface shown in FIG. 4A are not particularly limited, and the user interface may adopt any other formats as long as required functions can be implemented.

[Document Search]

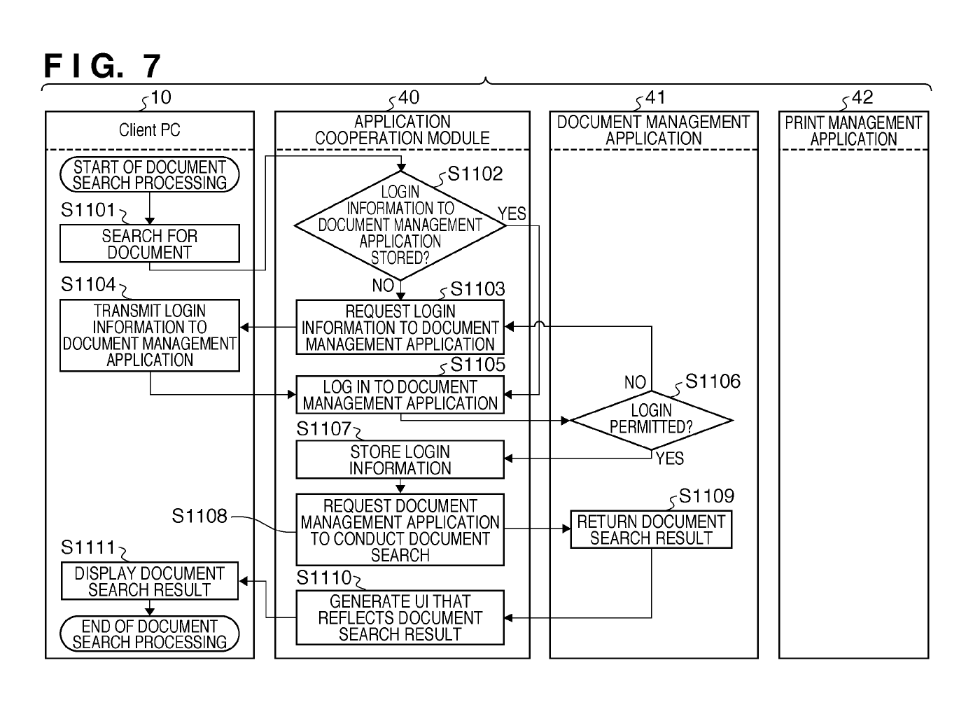

In step S102, user A searches the document management application 41 for documents via the application cooperation module 40 by operating the browser 200 of the Client PC 10. FIG. 7 is a flowchart showing the sequence of document search processing from the document management application via the application cooperation module 40. The document search processing will be described in detail below using FIGS. 3, 4A, and 7.

In step S1101, user A searches the document management application for documents by operating the browser 200 of the Client PC 10. More specifically, user A searches the document management application for documents by operating the tree view of the repository area 601 in FIG. 4A or by inputting a search keyword in the search window 602 in FIG. 4A. In step S1102, when user A issues a document search instruction via the browser 200 in step S1101, the communication unit 300 in the application cooperation module 40 receives a document search request. The processing control unit 301 receives a notification from the communication unit 300, and acquires a process corresponding to the request from user A from the processing content management unit 302. The processing control unit 301 determines according to the acquired process whether or not the authentication unit 303 stores login information to the document management application 41 associated with user A. If it is determined in step S1102 that no login information is stored, the processing control unit 301 acquires a user interface that requests the user to log in to the document management application 41 from the UI holding unit 309 in step S1103. The processing control unit 301 returns the user interface that requests the user to log in to the document management application 41 to the browser 200 as a response via the communication unit 300.

In step S1104, user A who received the login request in step S1103 inputs login information via the user interface displayed on the browser 200, and transmits that information to the application cooperation module 40. In step S1105, when user A transmits the login information via the browser 200 in step S1104, the communication unit 300 receives a login request. The processing control unit 301 receives a notification from the communication unit 300, acquires a process corresponding to the request from user A from the processing content management unit 302, and issues a login request to the document management application via the application cooperation unit 306 according to the acquired process. In step S1106, when the application cooperation module 40 issues the login request in step S1105, the connection unit 400 of the document management application 41 receives the login request. The connection unit 400 notifies the document management application main body 401 of the login request, and instructs the authentication unit 402 to determine whether or not to permit the login operation.

In step S1107, if it is determined in step S1106 that the login operation is permitted, the processing control unit 301 receives a login result to the document management application 41 via the application cooperation unit 306. The processing control unit 301 instructs the authentication unit 303 to temporarily store the login information to the document management application 41 in association with user A. Thus, user A is free from any troublesome login operations requested every time he or she accesses the document management application 41. Note that this embodiment has explained the case in which the login information to the document management application 41 is temporarily stored. Alternatively, using a database (not shown), the login information may be permanently held. Note that when login information to the document management application 41 linked with user A is already stored, this step may be skipped.

In step S1108, upon reception of the document search instruction from user A in step S1102, the processing control unit 301 issues a document search request to the document management application 41 via the application cooperation unit 306. In step S1109, when the application cooperation module 40 issues the document search request in step S1108, the connection unit 400 of the document management application 41 receives the document search request. The connection unit 400 notifies the document management application main body 401 of the document search request, and conducts a document search. In step S1110, when a document search result is acquired in step S1109, the processing control unit 301 reflects the document search result onto a user interface acquired from the UI holding unit 309, and returns that user interface to the browser 200 as a response via the communication unit 300. Note that reflecting the document search result indicates a state in which the tree view of the repository area 601 in FIG. 4A is expanded, a list of document stored under an expanded folder is displayed in the document list area 603. Alternatively, a list of documents which match the search keyword input to the search window 602 in FIG. 4A may be displayed in the document list area 603. The contents to be displayed as the search result are not limited to those shown in FIG. 4A, and they may be changed according to, for example, display contents set by the user. In step S1111, the user interface which reflects the document search result and is received in step S1110 is displayed on the browser 200 of the Client PC 10.

[Document Acquisition]

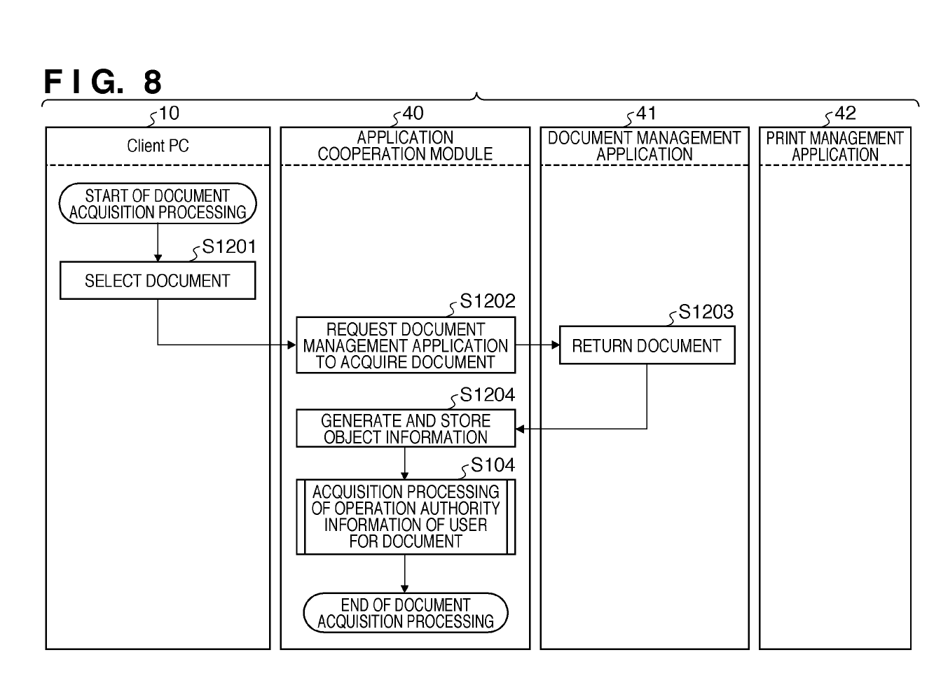

In step S103, user A selects a document in the document management application 41 via the application cooperation module 40 by operating the browser 200 of the Client PC 10. FIG. 8 is a flowchart showing the sequence of document acquisition processing in the document management application 41 via the application cooperation module 40. The document acquisition processing will be described in detail below using FIGS. 3, 4A, and 8.

In step S1201, user A selects a document in the document management application 41 by operating the browser 200 of the Client PC 10. More specifically, user A selects a document displayed in the document list area 603 in FIG. 4A. In step S1202, when the user selects the document via the browser 200 in step S1201, the communication unit 300 of the application cooperation module 40 receives a document selection request. The processing control unit 301 receives a notification from the communication unit 300, acquires a process corresponding to the request from user A from the processing content management unit 302, and issues a document acquisition request to the document management application 41 via the application cooperation unit 306 according to the acquired process.

In step S1203, when the application cooperation module 40 issues the document acquisition request in step S1202, the connection unit 400 of the document management application 41 receives the document acquisition request. The connection unit 400 notifies the document management application main body 401 of the document acquisition request, and acquires document information selected by the user. In this case, in the present invention, the document information may be binary data corresponding to a document or a local file path in the application server PC where the entity of the document is stored as long as it is information which is linked with data as the entity of the document. Also, the document information may include a file size, date of creation, and property information freely set by the user of the document itself.

In step S1204, based on the document information acquired from the document management application 41 in step S1203, the processing control unit 301 generates object information, and stores it in the object information management unit 305. More specifically, in the present invention, object information including an object as the acquired document information may be temporarily held on the RAM 101 or may be registered in a database (not shown). Then, in step S104 the processing control unit 301 acquires the operation authority of user A for the document information acquired in step S1204 from the document management application 41 via the application cooperation unit 306, and stores it in the object information management unit 305.

[Acquisition of Operation Authority]

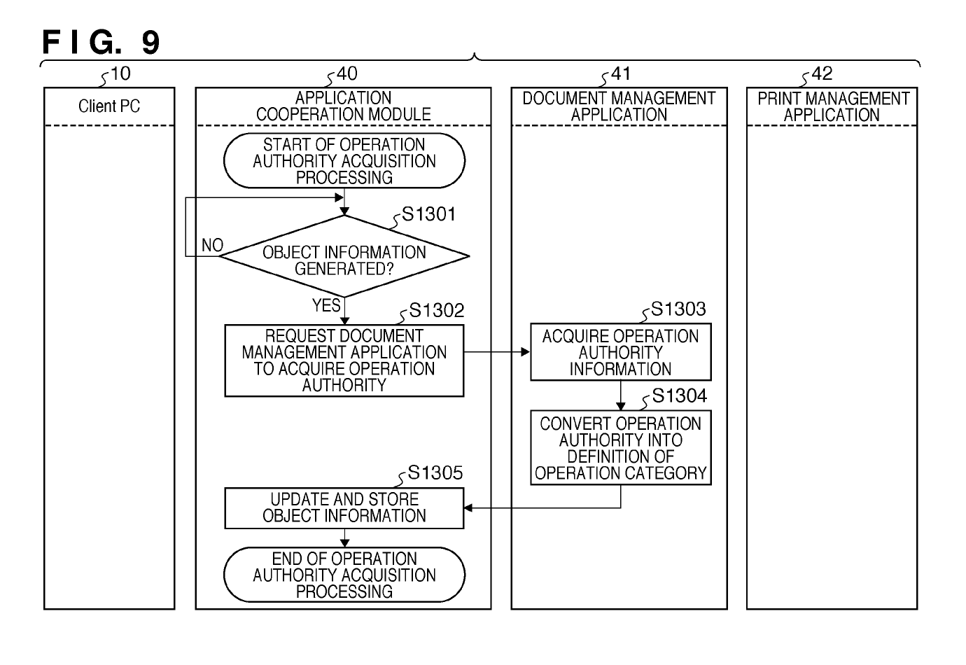

In step S104, the processing control unit 301 in the application cooperation module 40 acquires the operation authority of user A for the document acquired in step S103 from the document management application 41. FIG. 9 is a flowchart showing the sequence of processing executed when the application cooperation module 40 acquires the operation authority of user A for the document from the document management application. This processing will be described in detail below using FIGS. 3, 9, and 10A.

The object information management unit 305 determines in step S1301 whether or not object information associated with the document selected by the user in step S103 has been generated and stored. In this case, this step is automatically executed by the object information management unit 305 at the timing when the object information is generated and stored in the object information management unit 305. Hence, this step need not be defined or described as a sequence in each process stored in the processing content management unit 302. If it is determined in step S1301 that the object information has been generated and stored, the object information management unit 305 issues an acquisition request of the operation authority of user A for the document to the document management application 41 in step S1302. Assume that a unified interface used to acquire an operation authority of a user as needed is installed in respective applications which cooperate with the application cooperation module 40.

In step S1303, when the request is issued from the application cooperation unit 306 in step S1302, the connection unit 400 of the document management application 41 receives the acquisition request of the operation authority of user A for the document. In order to acquire operation authority information of user A for the document, the connection unit 400 controls the document management application main body 401 and authentication unit 402 to execute processing. In step S1304, the connection unit 400 converts the operation authority information of user A for the document, which is acquired in step S1303, into operation categories defined in the operation category holding unit 304 in the application cooperation module 40.

FIG. 10A shows an example of a definition file 700 which defines, in the connection unit 400, conversion rules of definitions of operation authorities in the document management application 41 into operation categories defined in the operation category holding unit 304 in the application cooperation module 40. The definition file 700 is prepared in advance so as to commonly and uniformly handle operation authorities of users, and is stored in or managed by the connection unit 400 as the premise of cooperations of the application cooperation module 40 of this embodiment and the document management application 41. Note that the present invention is not limited to the definition file 700 as long as the application cooperation module 40 can uniformly handle operation authorities of users upon cooperating a plurality of applications, and other method may be adopted. This embodiment will explain a case in which the document management application 41 defines operation authorities of users depending on groups to which they belong. However, other definitions may be used.

FIG. 10A shows, as an example, a rule for converting an operation authority of a user who belongs to an administrator group “admin” (701) into an operation category “ALL” (702) which indicates that “all operations are permitted” and is defined in the operation category holding unit 304. Other conversion examples are as follows.

To convert an operation authority of a “guest” user in the document management application 41 into an operation category “READ” which indicates that “only a read operation is permitted” and is defined in the operation category holding unit 304
To convert an operation authority of a “general1” user in the document management application 41 into operation categories “READ” and “UPLOAD” which indicate that “a read operation and update operation are permitted” and are defined in the operation category holding unit 304
To convert an operation authority of a “general2” user in the document management application 41 into operation categories “READ”, “UPLOAD”, “PRINT”, and “EDIT” which indicate that “read, update, print, and edit operations are permitted” and are defined in the operation category holding unit 304

In this case, this embodiment will give an explanation using the examples shown in FIG. 10A. However, other conversion rules may be defined, and the present invention is not limited to the examples shown in FIG. 10A.

In step S1305, the object information management unit 305 stores the converted operation authority (operation categories) of user A for the document information acquired in step S1304 as an object attribute of the object information.

With the processes executed so far, in this system, the print management application 42 need not individually install processing for confirming/acquiring an operation authority of a user for an object acquired from the document management application 41. Thus, interdependency between applications to be cooperated can be excluded.

[UI Display]

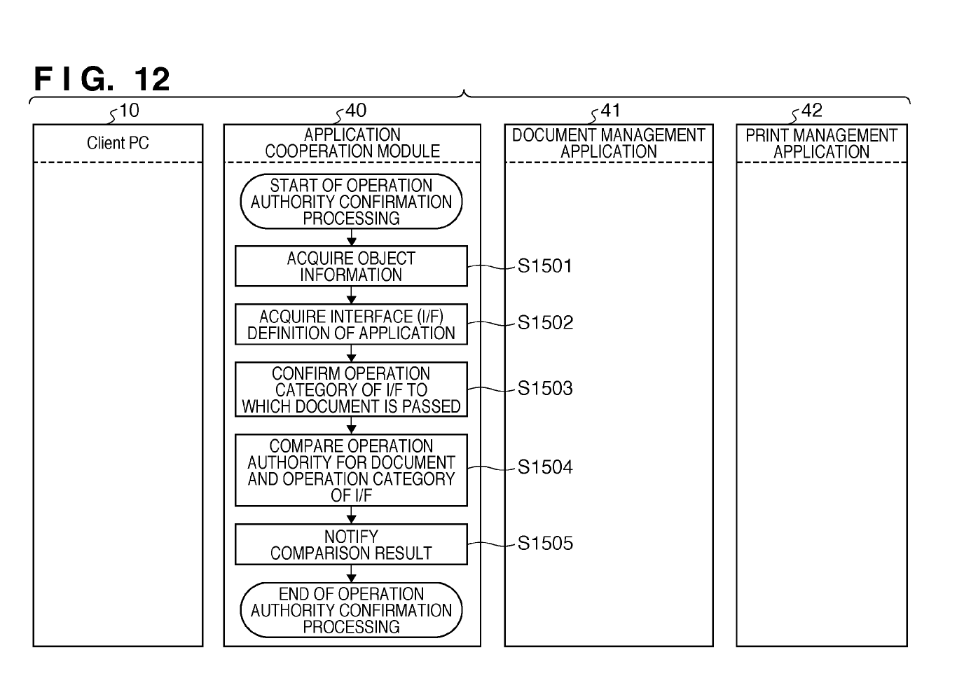

In step S105, the processing control unit 301 in the application cooperation module 40 returns the user interface including invalidated controls of the document for which user A does not have any operation authority to the browser 200, and displays that user interface on the browser 200. FIG. 11 is a flowchart showing the sequence of processing executed when the application cooperation module 40 returns a user interface according to the operation authority of user A for the document. This processing will be described in detail below using FIGS. 3 and 11.

In step S1401, in order to return the acquisition result of the document selected by user A in step S103, the processing control unit 301 in the application cooperation module 40 acquires a user interface from the UI holding unit 309. The processing control unit 301 determines in step S1402 whether or not logics (programs) for determining display/non-display modes of controls in the user interface acquired in step S1401 according to the operation authority of user A for the document are available. In this case, assume that functions permitted depending on the operation authority are displayed.

More specifically, a case will be described below wherein the user interface stored in the UI holding unit 309 is configured by HTML data including a program language such as server side scripting (for example, JSP). FIG. 4A as the example of the user interface of this embodiment includes the preview area 604 which displays the document selected by user A. Furthermore, the user interface includes the document submission button 605 and edit button 606, the display/non-display mode of which is determined according to the operation authority of user A for the document. The HTML data includes, as a program language, logics for determining the display/non-display modes of the two controls, that is, the document submission button 605 and edit button 606 according to the operation authority of user A for the document. Note that this embodiment will explain the configuration in which HTML data including the program language such as server side scripting is stored in the UI holding unit 309. However, the user interface may be configured by other method. For example, in order to obtain the same effects and display result upon displaying the user interface on the browser 200, Java Script® may be used.

If it is determined in step S1402 that the logics for determining the display/non-display mode of controls according to the operation authority are available, the processing control unit 301 executes a program such as server side scripting in step S1403 (to be described later). The processing control unit 301 determines using the execution result whether or not to display controls in the user interface. In step S1404, after the display/non-display confirmation result of controls according to the operation authority of user A is obtained in step S1403, the processing control unit 301 reflects the display/non-display modes of the controls in the user interface. More specifically, when user A has no print authority for the document (which is not permitted), the document submission button 605 in FIG. 4A is not displayed. When user A does not have any edit authority for the document (which is not permitted), the edit button 606 in FIG. 4A is not displayed. In step S1405, after all the logics (programs) for determining the display/non-display mode of the controls have been processed in step S1402, the user interface to which the display/non-display modes of the controls are reflected is returned to and displayed on the browser 200. Note that the preview area 604 displays a preview and property information of the document selected by user A at the same time.

Thus, the user can be prevented from pressing any controls for which he or she does not have any operation authority for the document. Also, any of an inquiry to an external system, unnecessary processing, and network communications, which are generated upon operations of the controls for which the user does not have any operation authority, can be avoided.

[Confirmation of Operation Authority]

In step S1403, the processing control unit 301 in the application cooperation module 40 executes the programs for determining whether or not to display the controls in the user interface using the operation authority of user A for the document. More specifically, the processing control unit 301 determines, using the operation authority of user A for the document, whether or not to execute a process generated when user A operates a given control in the user interface, that is, whether or not to call an interface provided by the application. FIG. 12 is a flowchart showing the sequence of processing executed when the application cooperation module 40 compares the operation authority of user A for the document and an interface definition provided by the application. This processing will be described in detail below using FIGS. 3, 10B, and 12.

In step S1501, the processing control unit 301 acquires the object information of the document selected by user A from the object information management unit 305. More specifically, the processing control unit 301 acquires the operation authority (operation categories) of user A for the document, which is stored as the object information. In step S1502, the processing control unit 301 acquires a definition of an interface of the application, which is called when the user operates a given control embedded in the user interface in step S1402. This embodiment will explain a case in which the definition of the user interface describes that an interface provided by the print management application 42 is called upon pressing of the document submission button 605 in FIG. 4A. The processing control unit 301 acquires the interface definition of the print management application 42 to be called upon operation of the document submission button 605 from the application information holding unit 307.

FIG. 10B shows an example of a definition file 800 which defines interface information of the print management application 42. The definition file 800 is prepared in advance and is held in the application information holding unit 307 as the premise of cooperations of the application cooperation module 40 of this embodiment and the print management application 42. In this embodiment, the print management application 42 provides two interfaces, that is, “PutDocument” as one interface which is called upon submitting a document, and “PrintDocument” as the other interface which is called upon printing a document. Furthermore, the definition file 800 declares using operation categories defined in the operation category holding unit 304 in the application cooperation module 40 for the purpose of defining processing contents to be executed for an object received by the respective interfaces. That is, the definition file 800 defines the correspondence between the processing contents to be executed by the application for an object, and operation categories. More specifically, “PutDocument” (801) declares operation categories “UPLOAD” and “PRINT” (802) which indicate that “registration and print operations are performed” and are defined in the operation category holding unit 304. Furthermore, “PrintDocument” (803) declares an operation category “PRINT” (804) which indicates that “a print operation is performed”. Note that the file that defines the interface information need not describe all interfaces provided by the print management application. That is, the file may describe about minimum required interfaces which execute arbitrary processes for a received object. As for the definitions of the respective interfaces, information other than operation categories may be declared.

In step S1503, after the interface definition of the print management application 42 is acquired in step S1502, the processing control unit 301 confirms operation categories of the interface called upon operation of the document submission button 605. In this embodiment, “UPLOAD” and “PRINT” (802) declared as the processing contents of the interface “PutDocument” (801) provided by the print management application 42 are acquired as operation categories. In step S1504, the processing control unit 301 requests the access authority determination unit 308 to compare the operation authority of user A for the document, which is acquired in step S1501, and the operation categories of the interface of the print management application 42, which are acquired in step S1503. For example, when only “READ” is permitted as the operation authority of user A for the document, since the interface “PutDocument” of the print management application 42 requires operation categories “UPLOAD” and “PRINT”, it is determined that user A has no authority to call “PutDocument”. On the other hand, when “READ”, “UPLOAD”, “PRINT”, and “EDIT” are permitted as the operation authority of user A for the document, since the interface “PutDocument” of the print management application 42 requires operation categories “UPLOAD” and “PRINT”, it is determined that user A has an authority to call “PutDocument”.

In step S1505, the access authority determination unit 308 notifies the processing control unit 301 of the comparison unit in step S1504 between the operation authority of user A for the document and the operation categories defined in the interface of the print management application 42.

In this manner, the application cooperation module 40 acquires an authority for an object together with the object from the document management application 41. Then, the application cooperation module 40 determines based on the acquired authority information whether or not to permit a user to operate a next cooperation application (the print management application 42 in this case). Then, the cooperation application need not individually install processing for confirming/acquiring the operation authority of the user. As a result, interdependency between applications can be excluded.

Also, since the application cooperation module 40 can determine whether or not to allow to execute processing for an object before an interface provided by the application is called, unnecessary network communications and the like in a distributed environment can be avoided.

### Second Embodiment

As a difference between application cooperation systems according to the second and first embodiments of the present invention, user A can instruct selection of a document from a document management application 41 and submission of the document to a print management application 42 as a series of processes. FIG. 4B shows an example of a user interface of an application cooperation module 40 according to this embodiment, which is displayed on a browser 200 of a Client PC 10.

Contents of steps, which are different from those in the aforementioned embodiment, of the processes in respective steps of the application cooperation system according to this embodiment will be described below with reference to FIGS. 3, 4B, 13, 14, and 15.

[Submission and Printing of Document Based on Operation Authority]

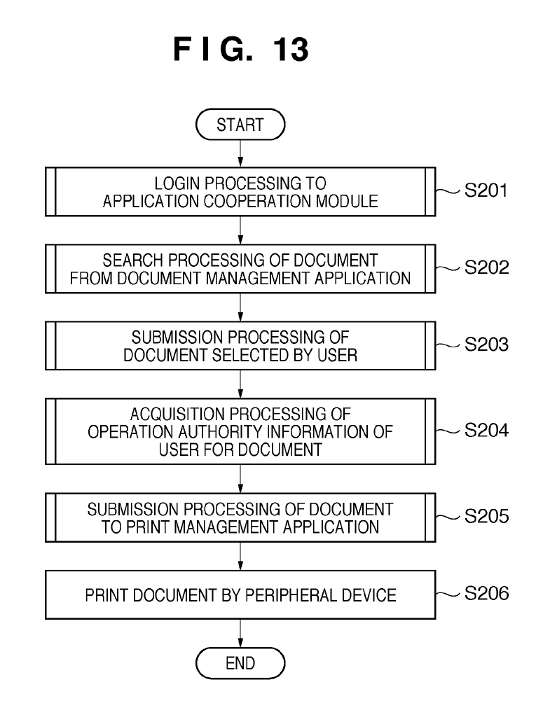

User A operates a UI to submit and print a document using the application cooperation module 40 according to this embodiment via the browser 200 of the Client PC 10. FIG. 13 is a flowchart showing an overview of processing for submitting and printing a document. This processing will be described below using FIGS. 3 and 13.

In step S201, when a communication unit 300 of the application cooperation module 40 according to this embodiment receives a login instruction from user A via the browser 200, a processing control unit 301 controls an authentication unit 303 to confirm whether or not to permit a login operation. Since this step is the same as step S101 in FIG. 5 in the first embodiment, a detailed description thereof will be avoided. In step S202, when the communication unit 300 receives a document search instruction from user A via the browser 200, the processing control unit 301 acquires a document search result from the document management application 41 via an application cooperation unit 306. Since this step is the same as step S102 in FIG. 5 in the first embodiment, a detailed description thereof will be avoided.

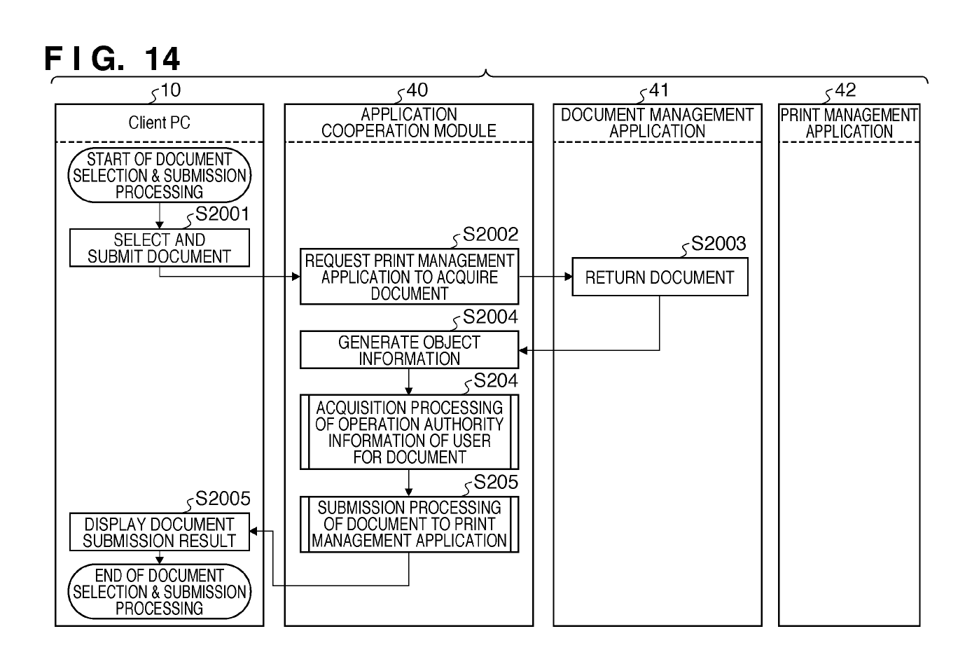

In step S203, when the communication unit 300 receives a document selection instruction and a document submission instruction to the print management application from user A via the browser 200, the processing control unit 301 acquires document information from the document management application 41. The processing control unit 301 stores an object as the acquired document information in an object information management unit 305 as object information. This step will be described in detail later using FIG. 14.

In step S204, the processing control unit 301 acquires an operation authority of user A for the document information acquired in step S203 from the document management application 41, updates the object information by the acquired operation authority, and stores the updated object information in the object information management unit 305. Since this step is the same as step S104 in FIG. 5 in the first embodiment, a detailed description thereof will be avoided.

In step S205, the processing control unit 301 acquires a definition file of interfaces of the print management application 42, which is held in an application information holding unit 307. Next, an access authority determination unit 308 compares the operation authority of user A for the document, which is acquired in step S204, and operation categories described in the definition file of the interfaces of the print management application 42. The processing control unit 301 determines based on the comparison result whether or not user A has an operation authority to print the document, and submits the document information to the print management application 42. In step S206, user A executes a print operation via peripheral devices 30, 31, and 32 based on the document information submitted to the print management application 42 in step S205. As for the print methods in the peripheral devices 30, 31, and 32, the user may access the print management application 42 from an operation panel (not shown) of each of the peripheral devices 30, 31, and 32 to execute a print operation. Alternatively, the user may operate a user interface (not shown) displayed on the browser 200 of the Client PC 10 to execute a print operation from the print management application 42 using the peripheral devices 30, 31, and 32.

[Selection and Submission of Document]

In step S203, user A selects a document in the document management application 41 via the application cooperation module 40, and submits the selected document to the print management application 42 by operating the browser 200 of the Client PC 10. FIG. 14 is a flowchart showing the sequence of processing for selecting a document in the document management application and submitting the document via the application cooperation module 40. This processing will be described in detail below using FIGS. 3, 4B, and 14.

In step S2001, user A selects a document in the document management application 41 and submits the selected document to the print management application 42 by operating the browser 200 of the Client PC 10. More specifically, user A displays an operation menu 607 while he or she selects the document displayed in a document list area 603 in FIG. 4B, and selects “document submission”. In step S2002, after user A issues document selection and submission instructions via the browser 200 in step S2001, the communication unit 300 in the application cooperation module 40 receives a document selection request. The processing control unit 301 receives a notification from the communication unit 300, acquires a process corresponding to the request from user A from a processing content management unit 302, and issues a document acquisition request to the document management application 41 via the application cooperation unit 306 in accordance with the acquired process.

In step S2003, when the application cooperation module 40 issues the document acquisition request in step S2002, a connection unit 400 of the document management application 41 receives the document acquisition request. The connection unit 400 notifies a document management application main body 401 of the document acquisition request, and acquires document information. In step S2004, based on the document information acquired from the document management application 41 in step S2003, the processing control unit 301 generates object information, and stores it in the object information management unit 305.

In step S204, the processing control unit 301 acquires an operation authority of user A for the document acquired in step S2004 from the document management application 41 via the application cooperation unit 306, and stores it in the object information management unit 305. Note that this step is the same as step S104 in FIG. 8 in the first embodiment and all the steps in FIG. 9 which shows details of step S104, and a detailed description thereof will be avoided. In step S205 to be described later, the processing control unit 301 submits, using the object information acquired in step S204, the document information, which is selected by user A and is acquired, to the print management application 42 via the application cooperation unit 306. In step S2005, a user interface which reflects the document submission result in step S204 is displayed on the browser 200 of the Client PC 10.

[Document Submission to Print Management Application]

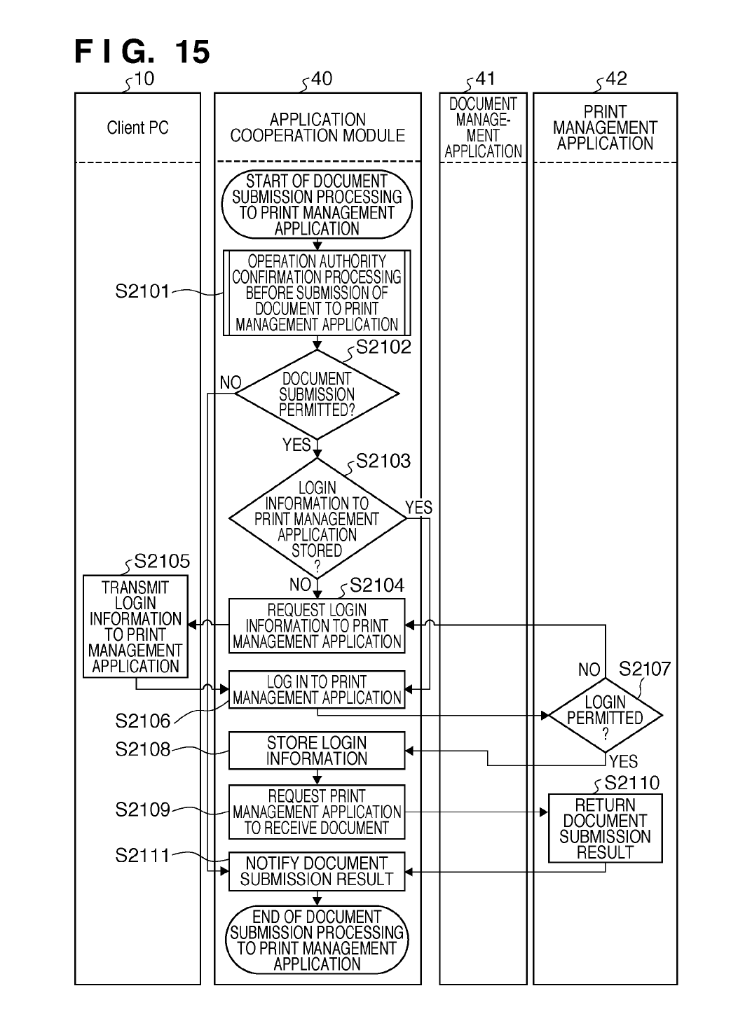

In step S205, the processing control unit 301 in the application cooperation module 40 submits the document information, which is instructed to select and submit by user A, and is acquired, to the print management application 42. FIG. 15 is a flowchart showing the sequence of processing executed when the application cooperation module 40 submits a document to the print management application 42 according to the operation authority of user A for the document. This processing will be described in detail below using FIGS. 3 and 15.

In step S2101 to be described later, the processing control unit 301 confirms according to the operation authority of user A for the document whether or not to allow submission of the document to the print management application 42. This process corresponds to that shown in FIG. 12 described in the first embodiment. If it is determined in step S2102 as a result of the confirmation process in step S2101 that the document information cannot be submitted to the print management application 42 according to the operation authority of user A, the processing control unit 301 jumps the process to step S2111, thus ending the processing. If it is determined as a result of the confirmation process in step S2101 that the document information can be submitted to the print management application 42, the processing control unit 301 determines in step S2103 if the authentication unit 303 stores login information to the print management application 42 associated with user A.

If it is determined in step S2103 that the login information is stored, the processing control unit 301 acquires a user interface that requests the user to log in to the print management application 42 from a UI holding unit 309 in step S2104. The processing control unit 301 returns the user interface that requests the user to log in to the print management application 42 to the browser 200 as a response via the communication unit 300. In step S2105, user A who received a login request in step S2104 inputs login information via the user interface displayed on the browser 200, and transmits the information to the application cooperation module 40. In step S2106, when user A transmits the login information via the browser 200 in step S2105, the communication unit 300 receives the login request. The processing control unit 301 receives a notification from the communication unit 300, acquires a process corresponding to the request from user A from the processing content management unit 302, and issues a login request to the print management application via the application cooperation unit 306 according to the acquired process.

In step S2107, when the application cooperation module 40 issues the login request in step S2106, a connection unit 500 of the print management application 42 receives the login request. The connection unit 500 notifies a print management application main body 501 of the login request, and instructs an authentication unit 502 to determine whether or not to permit a login operation. In step S2108, if it is determined in step S2107 that the login operation is permitted, the processing control unit 301 receives a login permission result to the print management application 42 via the application cooperation unit 306. The processing control unit 301 instructs the authentication unit 303 to temporarily store the login information to the print management application 42 in association with user A. Thus, user A is free from any troublesome login operations requested every time he or she accesses the print management application 42. Note that this embodiment has explained the case in which the login information to the print management application 42 is temporarily stored. Alternatively, using a database (not shown), the login information may be permanently held. Note that when login information to the print management application 42 associated with user A is already stored, this step may be skipped.

In step S2109, in response to the document submission instruction from user A in step S2001, the processing control unit 301 issues a document submission request to the print management application 42 via the application cooperation unit 306. In step S2110, when the application cooperation module 40 issues the document submission request in step S2109, the connection unit 500 of the print management application 42 receives the document submission request. The connection unit 500 notifies the print management application main body 501 of the document submission request, and executes document reception processing. In step S2111, the processing control unit 301 receives a determination result indicating that the document information cannot be submitted to the print management application 42 according to the operation authority of user A in step S2101 or the document information reception result executed in step S2110. Then, the processing control unit 301 acquires a user interface indicating the document submission result to the print management application 42 from the UI holding unit 309, and returns it to the browser 200 as a response via the communication unit 300.

[Confirmation of Operation Authority]

In step S2101, the processing control unit 301 in the application cooperation module 40 confirms according to the operation authority of user A for the document whether or not to allow submission of document information to print management application 42. The confirmation processing of the operation authority in this embodiment is the same as that (FIG. 12) of the first embodiment. The sequence of the operation authority confirmation processing will be described in detail below using FIGS. 3, 10B, and 12 in correspondence with this embodiment.

In step S1501, the processing control unit 301 acquires the object information of the document selected by user A from the object information management unit 305. More specifically, the processing control unit 301 acquires the operation authority (operation categories) of user A for the document. In step S1502, the processing control unit 301 acquires, from the application information holding unit 307, a definition of an interface of the print management application 42, which is called when the user submits the document information, according to the process acquired in step S2002. FIG. 10B shows an example of a file 800 which defines interface information of the print management application 42. The definition file of the interface information is the same as that in the first embodiment, and a detailed description thereof will not be repeated.

In step S1503, after the interface definition of the print management application 42 is acquired in step S1502, the processing control unit 301 confirms operation categories which define the processing contents of the interface called upon submission of the document information. In this embodiment “UPLOAD” and “PRINT” (802) declared as the processing contents of an interface “PutDocument” (801) provided by the print management application 42 are acquired as operation categories. In step S1504, the processing control unit 301 requests the access authority determination unit 308 to compare the operation authority of user A for the document, which is acquired in step S1501, and the operation categories defined in the interface of the print management application 42, which are acquired in step S1503. Since the comparison processing is the same as that in the first embodiment, a detailed description thereof will not be repeated. In step S1505, the access authority determination unit 308 notifies the processing control unit 301 of the comparison result in step S1504 between the operation authority of user A for the document and the operation categories defined in the interface of the print management application 42.

According to this embodiment, even when a plurality of applications cooperate with each other in a series of processes, another application need not individually install processing for confirming the operation authority of a user for an object acquired from a certain application. Then, interdependency between applications can be excluded. Before an interface provided by an application is called, whether or not to execute processing for an object can be determined, thus avoiding unnecessary network communications, execution of unnecessary processing, and the like.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-229996, filed Oct. 1, 2009, which is hereby incorporated by reference herein in its entirety.

What is claimed is:

1. An application cooperation method in a system which comprises storage unit, and cooperation unit for cooperating a plurality of applications, managed by different access authorities, by exchanging an object between the plurality of applications, the method comprising:
a holding step of holding correspondence between functions provided by applications and operation categories which categorize operation contents for the object by the functions provided by the applications;
an acquisition step of acquiring an object managed by a first application, and acquiring an operation authority of a user for the object managed by the first application;
an object information management step of storing and managing, as object information, the object and the operation authority for the object acquired in the acquisition step in the storage unit; and
a determination step of determining whether or not operation categories held in the holding step in correspondence with functions of a second application which processes the object managed as the object information in the object information management step are permitted for the operation authority for the object managed as the object information,
wherein the operation categories are defined to be commonly used between the plurality of applications,
the cooperation unit does not pass the object managed as the object information in the object information management step to the second application at the time of execution of the function provided by the second application corresponding to the operation category which is not permitted according to a result in the determination step, and
the cooperation unit passes the object managed as the object information in the object information management step to the second application at the time of execution of the function provided by the second application corresponding to the operation category which is permitted according to the result in the determination step.

2. The method according to claim 1, wherein in the acquisition step, the operation authority which defines an authority of the user for the object managed by the first application depending on the operation categories is acquired.

3. The method according to claim 1, further comprising:
a providing step of providing, to the user, a screen used to instruct execution of the functions provided by the second application,
wherein in the providing step, a screen which limits the user from instructing the function provided by the second application corresponding to the operation category which is not permitted according to the result in the determination step is provided.

4. The method according to claim 1, further comprising:
a notification step of notifying, when the user instructs to execute the function provided by the second application corresponding to the operation category which is not permitted according to the result in the determination step, that the instructed function is not permitted.

5. The method according to claim 1, wherein the object is one of binary data corresponding to a document managed by the first application, and information which includes a local file path of a device which stores data as the document itself and is linked with the document.

6. The method according to claim 1, wherein the operation categories define at least two operations of create, reading, update, delete, print, copy, and move operations of the object.

7. The method according to claim 1, wherein the system includes a plurality of apparatuses which respectively provide functions by the plurality of applications.

8. A system which comprises cooperation unit for cooperating a plurality of applications, managed by different access authorities, by exchanging an object between the plurality of applications, said system comprising:
holding unit for holding correspondence between functions provided by applications and operation categories which categorize operation contents for the object by the functions provided by the applications;
acquisition unit for acquiring an object managed by a first application, and acquiring an operation authority of a user for the object managed by the first application;
object information management unit for managing, as object information, the object and the operation authority for the object acquired by said acquisition unit; and
determination unit for determining whether or not operation categories held by said holding unit in correspondence with functions of a second application which processes the object managed as the object information by said object information management unit are permitted for the operation authority for the object managed as the object information,
wherein said cooperation unit processes not to pass the object managed as the object information by said object information management unit to the second application at the time of execution of the function provided by the second application corresponding to the operation category which is not permitted according to a result of said determination unit,
said cooperation unit processes to pass the object managed as the object information by said object information management unit to the second application at the time of execution of the function provided by the second application corresponding to the operation category which is permitted according to the result of said determination unit, and
the operation categories are defined to be commonly used between the plurality of applications.

9. The system according to claim 8, wherein said acquisition unit acquires the operation authority which defines an authority of the user for the object managed by the first application, depending on the operation categories.

10. The system according to claim 8, further comprising:
providing unit for providing, to the user, a screen used to instruct execution of the functions provided by the second application,
wherein said providing unit provides a screen which limits the user from instructing the function provided by the second application corresponding to the operation category which is not permitted according to the result of said determination unit.

11. The system according to claim 8, further comprising:
notification unit for, when the user instructs to execute the function provided by the second application corresponding to the operation category which is not permitted according to the result of said determination unit, notifying that the instructed function is not permitted.

12. The system according to claim 8, wherein said system includes a plurality of apparatuses which respectively provide functions by the plurality of applications.

13. A computer-readable medium storing a program for controlling a computer to execute steps included in an application cooperation method according to claim 1.

14. An information processing apparatus which comprises cooperation unit for cooperating a plurality of applications, managed by different access authorities, by exchanging an object between the plurality of applications, said apparatus comprising:
holding unit for holding correspondence between functions provided by applications and operation categories which categorize operation contents for the object by the functions provided by the applications;
acquisition unit for acquiring an object managed by a first application, and acquiring an operation authority of a user for the object managed by the first application;
object information management unit for managing the object and the operation authority for the object acquired by said acquisition unit as object information; and
determination unit for determining whether or not operation categories held by said holding unit in correspondence with functions of a second application which processes the object managed as the object information by said object information management unit are permitted for the operation authority for the object managed as the object information,
wherein said cooperation unit does not pass the object managed as the object information by said object information management unit to the second application at the time of execution of the function provided by the second application corresponding to the operation category which is not permitted according to a result of said determination unit,
said cooperation unit passes the object managed as the object information by said object information management unit to the second application at the time of execution of the function provided by the second application corresponding to the operation category which is permitted according to the result of said determination unit, and
the operation categories are defined to be commonly used between the plurality of applications.
